(19) United States
(12) Patent Application Publication
(10) Pub. No.: US 2025/0315627 A1
(43) Pub. Date: Oct. 9, 2025

(54) MACHINE-LEARNING-BASED IDENTIFICATION OF USER INTERESTS

(71) Applicant: ModuleQ, Inc., Cupertino, CA (US)

(72) Inventors: Anupriya ANKOLEKAR, Zürich (CH); David James BRUNNER, Los Altos Hills, CA (US)

(73) Assignee: ModuleQ, Inc., Cupertino, CA (US)

(21) Appl. No.: 19/172,477

(22) Filed: Apr. 7, 2025

Related U.S. Application Data
(60) Provisional application No. 63/631,376, filed on Apr. 8, 2024.

(51) Int. Cl. G06F 40/35; G06N 5/022

(52) U.S. Cl. CPC G06F 40/35; G06N 5/022

(57) ABSTRACT

A method for providing user-specific content recommendations to a user may comprise selecting a user interest from a plurality of predefined user interests, extracting user activity data associated with the selected user interest, constructing a context data structure associated with the selected user interest based on a predefined knowledge graph data structure associated with the plurality of predefined user interests, generating one or more new user interests by providing the constructed context data structure and the user activity data to a trained machine learning model, generating a user-specific content recommendation based on the one or more new user interests, and providing the user-specific content recommendation to the user.

### CROSS-REFERENCE TO RELATED APPLICATIONS

This application claims the benefit of U.S. Provisional Application No. 63/631,376, filed Apr. 8, 2024, the entire content of which is hereby incorporated by reference herein.

### FIELD

The present disclosure relates generally to techniques for constructing contextual data structures for prompting machine learning models to accurately and efficiently identify user-specific interests from electronic data (e.g., electronic communication data).

### BACKGROUND

A person's electronic data (e.g., emails, instant messages, videoconference calls, and the like) can encompass valuable personal and professional information about the person. However, it is difficult to process the person's electronic data to derive meaningful and relevant insights into the person's personal and professional interests due to the copious amount of information available. Without proper context, the large volume of available data can cause analytic algorithms to be excessively inclusive when determining the person's interests. For example, if an analytic algorithm processes a person's work emails in the same way that it processes the person's spam emails, then that analytic algorithm may generate a large set of user interests based on the content of the spam emails that is entirely irrelevant to the person. Furthermore, conventional analytic algorithms that are configured to identify a person's interests based on the person's electronic communication data are typically quite simplistic. The algorithms are typically only capable of extracting simple metadata from an electronic conversation and, as a result, frequently overlook rich information about the person that may be available in other aspects of the conversation.

### SUMMARY

Described are machine-learning-based techniques for identifying additional user interests from user activity data based on a set of predefined user interests. Each predefined user interest may be a hypothesized or confirmed interest of a user. The provided techniques may leverage a sophisticated contextualization mechanism that utilizes knowledge graphs for the set of predefined user interests to provide a machine learning model with a frame of reference through which it can interpret user activity data. New user interests that are identified by the machine learning model may be used to generate user-specific content recommendations that are aligned with the user's interests and, in a professional setting, can streamline the user's workflow.

The user activity data from which new interests are identified may include electronic communication data such as emails and instant messages as well as other items produced or received by the user, for example documents authored or edited by the user. Content recommendations may include news reports, meeting briefings, or business insights, and may be provided to the user via a graphical user interface for an electronic communication medium, for example a graphical user interface for an email application or a graphical user interface for an instant messaging application. Certain events—for example, upcoming meetings—may trigger the generation and provisioning of a content recommendation. The graphical user interface may include controls that allow the user to quickly provide feedback about the relevance of a content recommendation in order to improve future recommendations.

The disclosed techniques provide numerous technical advantages. In various embodiments, the techniques may improve the functioning of a computer by reducing processing power, battery usage, and memory requirements associated with providing user-specific content recommendations. User activity data is acquired for a user may, in some examples, be filtered according to the set of predefined user interests to obtain activity data associated with a specific predefined user interest. This filtering process enables a smaller volume of communication data to be provided to the machine learning model and significantly reduces noise in said data, thereby increasing the speed with which the model can identify interests that are relevant to the user. Additionally, the contextual information from the knowledge graph of the predefined user interests that is made available to the machine learning model may enable the machine learning model to extract and link concepts extracted from user activity data to real-world entities with high efficiency and accuracy.

A disclosed method for providing user-specific content recommendations to a user may include obtaining user activity data associated with the user. The user activity data may be associated with a predefined user interest of a plurality of predefined user interests associated with the user. A context data structure associated with the selected user interest based on a predefined knowledge graph data structure associated with the plurality of predefined user interests may then be constructed. One or more new user interests may be generated by providing the constructed context data structure and the user activity data to a trained machine learning model. A user-specific content recommendation may be generated based on the one or more new user interests. The user-specific content recommendation may be provided to the user.

Constructing the context data structure may involve acquiring metadata associated with the selected user interest from the predefined knowledge graph data structure, acquiring metadata associated with the user, and determining relationship data indicating one or more relationships between the metadata associated with the selected user interest and the metadata associated with the user.

The trained machine learning model can be a large language model. Providing the constructed context data structure and the user activity data to the trained machine-learning model may comprise generating a prompt for the large language model to identify one or more potential interests related to the selected user interest using the constructed context data structure and providing the prompt to the large language model. One or more relationships between the one or more potential interests identified by the large language model and data in the predefined knowledge graph data structure may then be determined. The one or more new user interests may be generated based on the one or more relationships between the one or more entities identified by the large language model and data in the predefined knowledge graph data structure.

In some embodiments, the method comprises generating, for each new user interest of the one or more new user interests, an importance score indicating a relevance of the respective new user interest to the user. Generating an importance score for a new user interest may involve mapping a large language model relevance category associated with the new user interest to a numerical value. The user-specific content recommendation may be generated based on the magnitudes of the importance scores for the one or more new user interests.

The method can further include receiving an indication of a recommendation trigger event and providing the user-specific content recommendation based on the recommendation trigger event. In some embodiments, a user request for additional information associated with the user-specific content recommendation is received and an updated user-specific content recommendation comprising the additional information in response to the user request is provided.

User feedback associated with the user-specific content recommendation may be received. A recommendation engine may be used to generate the user-specific content recommendation. One or more parameters associated with the recommendation engine may be updated based on the user feedback.

Providing the user-specific content recommendation may involve displaying a graphical user interface comprising the content recommendation on a computer system. The graphical user interface can be a graphical user interface for a communication platform. The user-specific content recommendation may include a news report associated with a new user interest of the one or more new user interests. The plurality of predefined user interests may be updated based on the one or more new user interests periodically or upon receipt of a threshold volume of user activity data.

A provided system for providing user-specific content recommendations to a user may comprise one or more processors configured to obtain user activity data associated with the user, wherein the user activity data is associated with a predefined user interest of a plurality of predefined user interests associated with the user; construct a context data structure associated with the selected user interest based on a predefined knowledge graph data structure associated with the plurality of predefined user interests; generate one or more new user interests by inputting the constructed context data structure and the user activity data to a trained machine-learning model; generate a user-specific content recommendation based on the one or more new user interests; and provide a user-specific content recommendation to the user.

A provided non-transitory computer readable storage medium may store instructions for providing user-specific content recommendations to a user that, when executed by one or more processors of a computer system, cause the computer system to: obtain user activity data associated with the user, wherein the user activity data is associated with a predefined user interest of a plurality of predefined user interests associated with the user; construct a context data structure associated with the selected user interest based on a predefined knowledge graph data structure associated with the plurality of predefined user interests; generate one or more new user interests by inputting the constructed context data structure and the user activity data to a trained machine-learning model; and generate a user-specific content recommendation based on the one or more new user interests; and provide a user-specific content recommendation to the user.

### BRIEF DESCRIPTION OF THE FIGURES

The following figures show various systems, methods, and apparatuses for identifying user interests and providing user-specific content recommendations. The systems, methods, and apparatuses shown in the figures may have any one or more of the characteristics described herein.

FIG. 1 shows a method for identifying new user interests and providing user-specific content recommendations, according to some embodiments.

FIG. 2 shows a process for filtering user activity data, according to some embodiments.

FIG. 3 shows a process for contextualizing user interests, according to some embodiments.

FIG. 4A shows a diagram of an exemplary knowledge graph, according to some embodiments.

FIG. 4B shows an example knowledge graph for an example user interest.

FIG. 4C shows another example knowledge graph for another example user interest.

FIG. 5 shows a process for prompting a large language model to identify previously unidentified entities in user activity data, according to some embodiments.

FIG. 6 shows a process for determining new user interests from entities identified in user activity data by a large language model, according to some embodiments.

FIG. 7 shows a process for generating a user-specific content recommendation, according to some embodiments.

FIG. 8A shows a graphical user interface for providing user-specific content recommendations, according to some embodiments.

FIG. 8B shows a graphical user interface for providing user-specific content recommendations prompting a user to provide a first type of user feedback, according to some embodiments.

FIG. 8C shows a graphical user interface for providing user-specific content recommendations prompting a user to provide a second type of user feedback, according to some embodiments.

FIG. 8D shows a graphical user interface providing a first type of content recommendation, according to some embodiments.

FIG. 8E shows a graphical user interface providing a first type of content recommendation, according to some embodiments.

FIG. 9 shows an exemplary computer system, according to some embodiments.

### DETAILED DESCRIPTION

Described are machine-learning-based systems, methods, apparatuses, and non-transitory computer readable storage media for identifying additional user interests from user activity data that have been contextualized using a set of predefined user interests. User activity data that has been filtered according to the predefined user interests, along with contextual information about a particular predefined user interest that has been ingested from a knowledge graph, may be provided to a trained machine learning model (e.g., a large language model) to generate new user interests. Newly identified user interests may then be used to generate and provide user-specific content recommendations to the user.

The user activity data from which new interests are identified may include electronic communication data such as emails and instant messages as well as other items produced or received by the user, for example documents authored or edited by the user. Content recommendations may include news reports, meeting briefings, or business insights, and may be provided to the user via a graphical user interface for an electronic communication medium, for example a graphical user interface for an email application or a graphical user interface for an instant messaging application. Certain events—for example, upcoming meetings—may trigger the generation and provisioning of a content recommendation. The graphical user interface may include controls that allow the user to quickly provide feedback about the relevance of a content recommendation in order to improve future recommendations.

The disclosed systems, methods, apparatuses, and non-transitory computer readable storage media provide numerous technical advantages. In various embodiments, the systems, methods, apparatuses, and non-transitory computer readable storage media may improve the functioning of a computer by reducing processing power, battery usage, and memory requirements associated with providing user-specific content recommendations. The processes for filtering the user activity data to obtain data associated with a specific predefined user interests may significantly reduce noise in the data that is provided to the machine learning model that generates the new user interests, increasing the speed with which new interests can be identified. Additionally, the contextual information from the knowledge graph that is input into the machine learning model may enable the machine learning model to extract and link concepts extracted from user activity data to real-world entities with high efficiency and accuracy.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

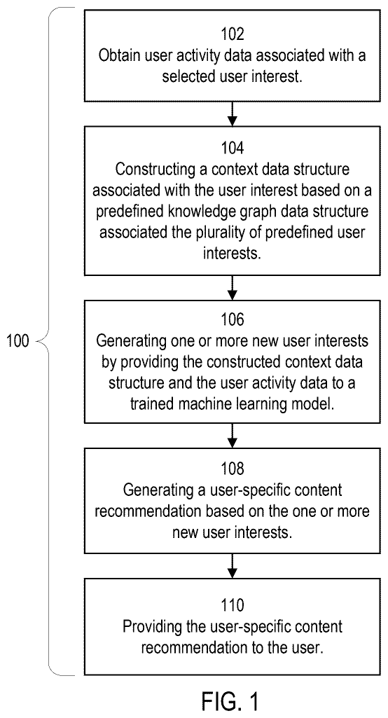

FIG. 1 shows an exemplary method 100 for identifying new user interests and providing user-specific content recommendations. Method 100 is performed, for example, using one or more electronic devices implementing a software platform. In some examples, method 100 is performed using a client-server system, and the blocks of method 100 are divided up in any manner between the server and a client device. In other examples, the blocks of method 100 are divided up between the server and multiple client devices. In other examples, method 100 is performed using only a client device or only multiple client devices. In method 100, some blocks are, optionally, combined, the order of some blocks is, optionally, changed, and some blocks are, optionally, omitted. In some examples, additional steps may be performed in combination with the method 100. In some examples, steps of method 100 may be performed in a different order than the order that is depicted in FIG. 1. Accordingly, the operations as illustrated (and described in greater detail below) are exemplary by nature and, as such, should not be viewed as limiting.

As shown, method 100 may include a step 102 wherein user activity data is obtained. The user activity data may be tied to a specific person or group of people and may be ingested from a computer system, a software environment, or server associated with the person or group of people. In some cases, for example, the user activity data is related to an employee of a company and may be ingested from the company's servers or from a company computer that has been assigned to the employee. In other cases, the user activity may be connected to a subscriber to or user of a media delivery service such as a video streaming service (e.g., Netflix), a music streaming service (e.g., Spotify), or an e-book delivery service (e.g., services associated with Amazon's Kindle), in which case the user activity data may be ingested from the media delivery service's servers or from a device that is used to receive media from the media delivery service (e.g., a personal computer, a television or game console such as Apple TV, an e-reader such as a Kindle, a mobile phone, etc.). In other cases, the user activity may be connected to a shopping service (e.g., Amazon). In other cases, the user activity data may be connected to a news service (e.g., Apple News). In other cases, the user activity data may be associated with a recommendation website such as LinkedIn.

The aforementioned examples are provided for illustrative purposes and are not intended to be limiting on the embodiments of the present disclosure.

The user activity data may include any suitable data that indicates a user's actions in an electronic environment. In particular, the user activity data may include the user's electronic communication data. The user's electronic communication data may comprise emails that the user has sent or received (including emails on which that the user has been copied (CC′d or BCC′d)). Electronic communication data can also include instant messages or live chats that have been sent or received by the user. Instant messages or chats may be received from an instant messaging application (e.g., WhatsApp, WeChat, Telegram, Google Meet/Chat, Skype, etc.), from a social media application with an associated instant messaging feature (e.g., Facebook Messenger, Snapchat, Instagram's Direct Messenger, etc.), from a group or business communication platform (e.g., Microsoft Teams, Slack, Skype for Business, Zoom, BlueJeans by Verizon, etc.), or any other suitable source. In some examples, the user's electronic communication data includes text messages that the user has sent and received. In other examples, the user's electronic communication data includes meeting agendas or recordings or transcriptions of video or voice calls in which the user was a participant or attendee.

In addition to the user's electronic communication data, the user activity data can include the user's contacts (e.g., the user's email address book) or the user's social media connections (e.g., Facebook friends, Instagram followers, etc.). The user activity data can further comprise files that the user has accessed, created, deleted, edited, or received or sent (e.g., as an attachment in an email). The files may comprise text files (e.g., Microsoft Word documents), image files (e.g., photographs), audio files (e.g., voice memos), video files (e.g., YouTube videos), multimedia files, or combinations thereof. Time-based or calendar-based data may also constitute the user activity data. For example, the user's electronic calendar (e.g., a Microsoft Outlook calendar or a Google calendar) may be included in the user activity data.

The user activity data can also include data recorded on the user's personal device. For example, the user activity data can include data indicating the user's web search history or data indicating the user's web browsing behaviors. In some embodiments, the user activity data includes data associated with the user's activity in an electronic environment or in an enterprise application. Such data may, for example, include data indicating the user's activity in a customer relationship management (CRM) software environment, data indicating the user's activity in enterprise communication channels, or data associated with the user's profile in an enterprise application.

The user activity data may correspond to or be acquired over a defined period of time. For example, the user activity data may include user activity data for a specific day, week, month, or year. In some examples, the user activity data spans multiple years. User activity data may be ingested periodically (e.g., once per week, once per month, once per year, etc.) or may be uploaded at the discretion of the user or another individual.

From the acquired user activity data, user activity data associated with a user interest may be obtained (step 102 of method 100). The user interest may be selected from a data structure storing a plurality of predefined user interests. A user interest may be, for example, a person (e.g., an author, an actor, a CEO, etc.), a product, a service, a scientific or technical field, a business sector, a career or professional path, a professional or personal project or task, an object, a location, an activity, a restaurant or type of cuisine, a genre (e.g., a movie genre, a book genre, a television genre, etc.), a style of music or clothing, a company, or any other topic or entity. The so-called “predefined” user interests may include any user interests identified prior to the execution of step 102.

In some examples, the plurality of predefined user interests may be based on a set of prior user interest hypotheses, e.g., using the techniques described in U.S. Pat. No. 11,593,741. In some examples, the plurality of predefined user interests can be identified based on the acquired user activity data, for instance by determining the types of files with which the user is interacting with or by determining the people with whom the user is communicating (e.g., via email, instant message, text message, etc.). This process may be performed manually or automatically, for example using natural language processors or computer vision models. In other examples, the plurality of predefined user interests are determined (e.g., hypothesized) based on the user's demographics. If the user is, e.g., an employee of a company, the user's demographics may be data indicating the user's role in the company, the user's clients, products or services offered for sale by the user, the user's academic or professional background, employees of the company that are supervised by the user, employees of the company that supervise the user, and so on. Similarly, if the user is a user of a media delivery service, the user's demographics may be data indicating the user's subscription tier, the user's geographic location, the user's age, the user's gender, or any other factor that may influence the media with which the user interacts. The plurality of predefined user interests may also be determined based on the interests of other members of an organization to which the user belongs, for instance other members of a company that employs the users, other members of a college or university in which the user is enrolled, or other members of a team or a club to which the user belongs. One or more of the plurality of predefined user interests may be provided by the user, for example through a survey.

User activity data may be collected in response to certain trigger events. Examples of trigger events include (but are not limited to) sending an email, receiving an email, creating a document, editing a document, downloading a document, scheduling a meeting, starting an electronic conversation (e.g., a conversation over MS Teams chat), or querying a search engine. User activity data can also be ingested automatically, for example periodically (e.g., every 24 hours, every 48 hours, every 72 hours, every week, every two weeks, every month, etc.).

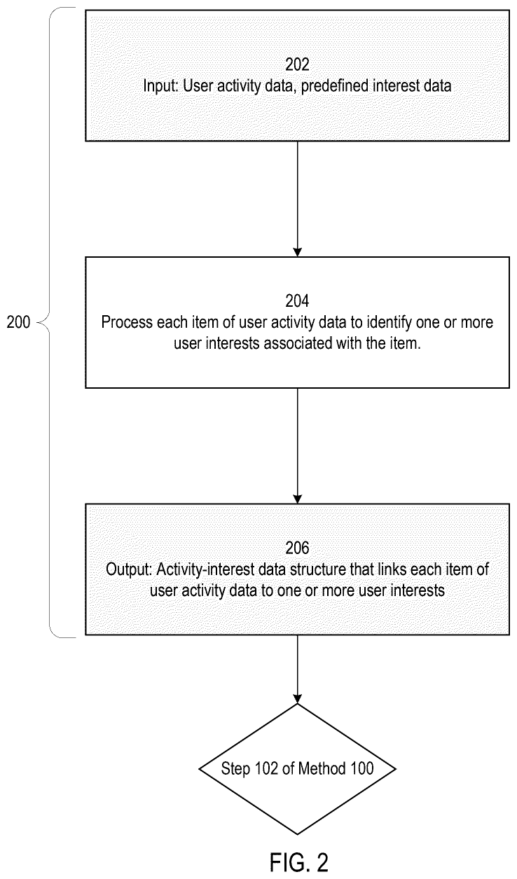

Obtaining user activity data associated with a specific user interest may require filtering the acquired user activity data according to the plurality of predefined user interests. FIG. 2 shows a process 200 for filtering user activity data. User activity data associated with a selected user interest may be extracted using process 200. Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. In some examples, steps of process 200 may be performed in a different order than the order that is depicted in FIG. 2. Accordingly, the operations as illustrated (and described in greater detail below) are exemplary by nature and, as such, should not be viewed as limiting.

As shown, the inputs to process 200 may include the acquired user activity data (e.g., a set D (u) containing the acquired user activity data) and data indicating the plurality of predefined user interests (the “predefined interest data”, e.g., a set/(u) containing the plurality of predefined user interests). Each item of user activity data (e.g., each item d in D (u)) in may be processed to identify one or more predefined user interests associated with the item (e.g., one or more predefined interests i in (u)—see block 204). This processing step may vary for each item of user activity data. Processing an email, for example, may involve extracting participants in the email via their email addresses and names. The extracted email addresses and names may be compared (e.g., by lexicographical matching) to email addresses and names in the user interest data. Example ways in which various types of user activity data may be processed at block 204 are provided in Table 1 below.

TABLE 1
User activity data processing examples

| Item of User | |
|---|---|
| Activity Data | Processing Details |
| Email, instant | Compare conversation participants |
| message | (indicated in the “To”, “From”, “CC”, |
| | and/or “BCC” fields) to people and |
| | organizations indicated in the |
| | predefined interest data to associate |
| | the email/instant message with |
| | people and organizations of interest. |
| Meeting agenda | Compare meeting attendee list to people |
| | and organizations indicated in |
| | the predefined interest data to associate |
| | the meeting agenda with people |
| | and organizations of interest. |
| Document | Examine document attributes (e.g., |
| | document authors, people with whom |
| | the document was shared, geography/ |
| | product/sector tags, etc.) to connect |
| | the document with interests indicated |
| | in the predefined interest data. |

The output of process 200 may be a data structure that links each acquired item of user activity data to one or more items of predefined interest data (the “activity-interest data structure”, e.g., a data structure containing subsets D′(u, i) of user activity data D(u) associated with each interest i in I(u)—see block 206). The activity-interest data structure may be filtered by user interest to obtain all items of the acquired user activity data that are associated with a given user interest (step 102 of method 100).

Returning to FIG. 1, after the user activity data associated with the selected user interest has been obtained, a context data structure associated with the selected user interest may be constructed (step 104 of method 100). The context data structure may be, e.g., a knowledge graph, a dictionary, or an associative array and may store data that frames, defines, or contextualizes the selected user interest in relation to the user and to the other predefined user interests. The context data structure may be constructed using a predefined knowledge graph data structure that is associated with the plurality of predefined user interests.

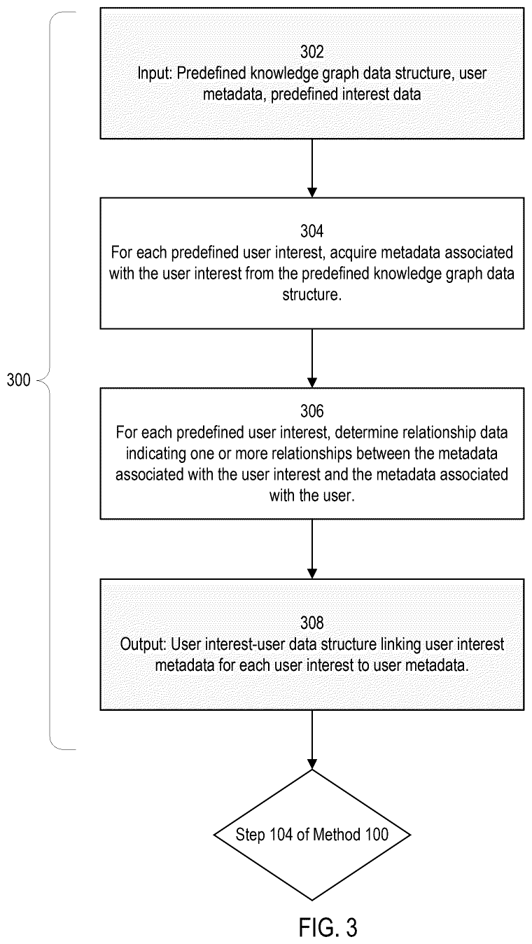

FIG. 3 shows a process 300 for contextualizing user interests using a predefined knowledge graph data structure. Process 300 may be executed during step 106 of method 100. Process 300 is performed, for example, using one or more electronic devices implementing a software platform. In some examples, process 300 is performed using a client-server system, and the blocks of process 300 are divided up in any manner between the server and a client device. In other examples, the blocks of process 300 are divided up between the server and multiple client devices. In other examples, process 300 is performed using only a client device or only multiple client devices. In process 300, some blocks are, optionally, combined, the order of some blocks is, optionally, changed, and some blocks are, optionally, omitted. In some examples, additional steps may be performed in combination with the process 300. In some examples, steps of process 300 may be performed in a different order than the order that is depicted in FIG. 3. Accordingly, the operations as illustrated (and described in greater detail below) are exemplary by nature and, as such, should not be viewed as limiting.

The inputs to process 300 may include the predefined interest data (e.g., the set I(u) containing the plurality of predefined user interests) and the predefined knowledge graph data structure (block 302). The knowledge graph data structure may store data associated with the plurality of predefined user interests in a graph-structured topology that indicates connections between the predefined user interests as well as connections between each predefined interest and its metadata (e.g., people, places, objects, events, topics, concepts, etc.). More specifically, the knowledge graph data structure may comprise a plurality of nodes connected by a plurality of edges. Each node may correspond to a predefined user interest or a metadata item (e.g., a person, a place, an object, an event, a topic, a concept, etc.) associated with a predefined user interest. The edges may indicate relationships between the nodes. The metadata may be acquired from various data sources, including news reports and web pages. In some examples, the predefined knowledge graph data structure may be compiled from data in an existing third-party knowledge graph such as Wikidata, and/or from other knowledge sources such as from company databases such as Crunchbase, from sector taxonomies such as GICS, or from financial content feeds such as the LSEG Company Data.

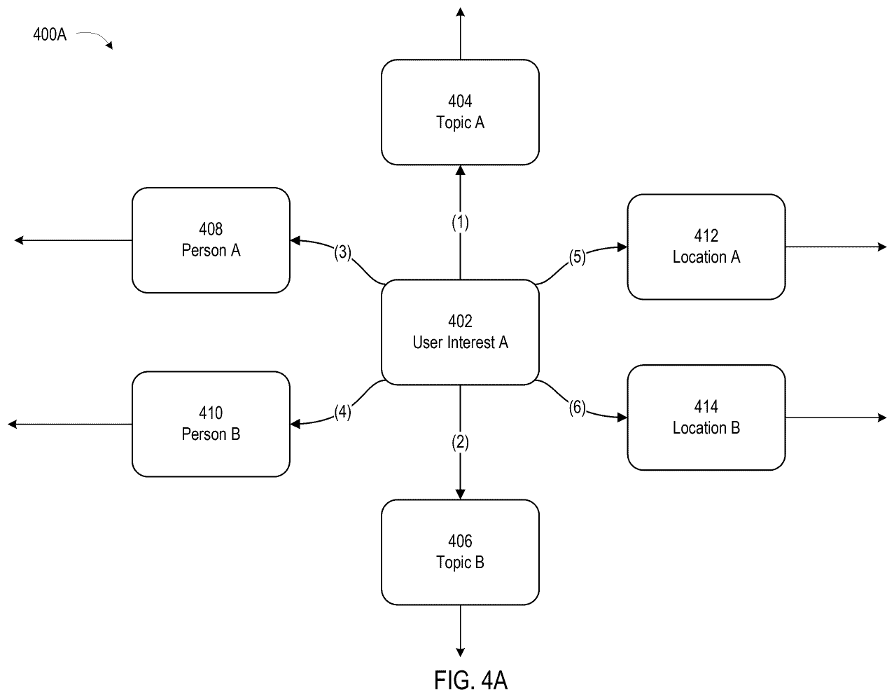

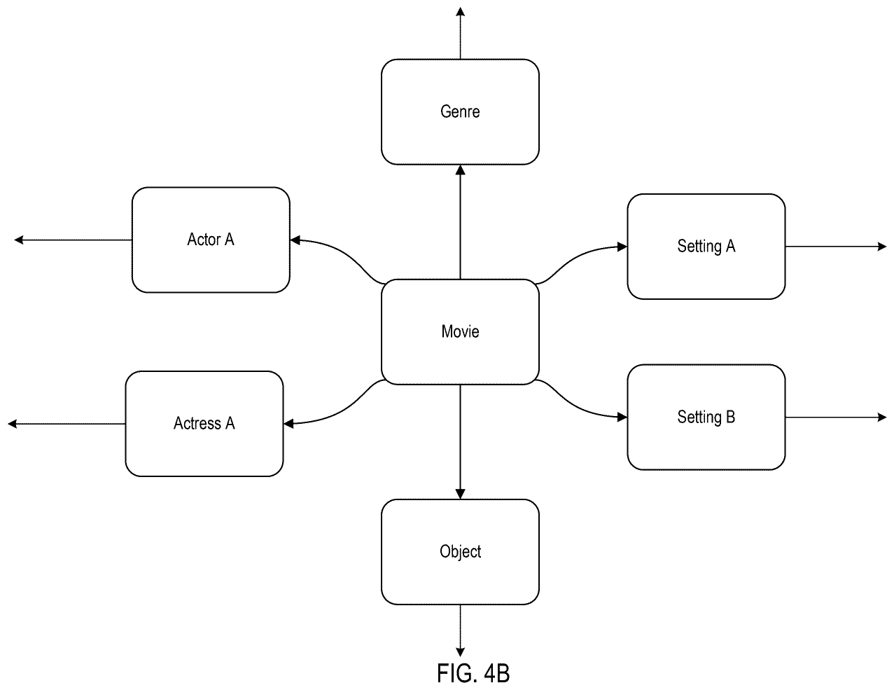

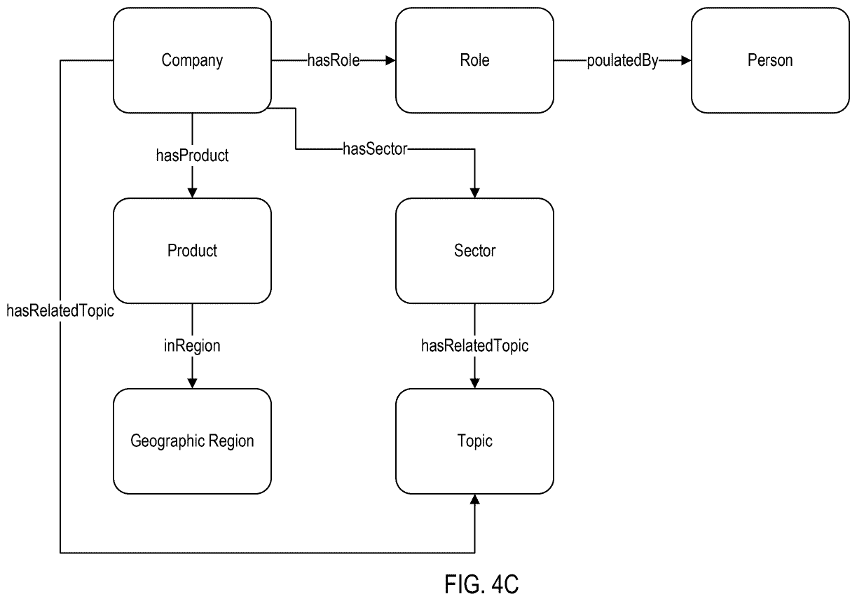

A portion 400A of an exemplary knowledge graph data structure is shown in FIG. 4A. A predefined user interest (labeled “User Interest A) in FIG. 4A)) may constitute a first node 402. Node 402 may be connected to nodes 404, 406, 408, 410, 412, and 414 by edges (1), (2), (3), (4), (5), and (6), respectively. Each node of nodes 404-406 may correspond to a metadata item that is associated with User Interest A. The metadata entities may include topics that are related to or that encompass User Interest A, people associated with User Interest A, and locations that are connected to User Interest A. Additional edges may connect nodes 404-414 to other portions of the knowledge graph data structure, for example to nodes corresponding to other predefined user interests. Further examples of knowledge graph data structures are provided in FIGS. 4B-4C.

In addition to the predefined interest data and the predefined knowledge graph data structure, the inputs to process 300 may include metadata associated with the user. The user metadata may comprise data indicating, e.g., the user's age, the user's gender, the user's educational background, and/or the user's role in a company or an organization. In some examples, the user metadata is provided by the user. In other examples, the user metadata is acquired from one or more data sources, for example the user's resume or CV or the user's profile in a software environment. In other examples, the user metadata is sourced from the user's profile in a software environment, for example the user's profile in a software environment associated with an organization of which the user is a member. In other examples, the user metadata may be obtained from the user's social media profile(s) or the user's personal or professional webpage.

In process 300, metadata for each predefined user interest indicated in the predefined interest data (e.g., each interest i in I(u)) may be acquired from the predefined knowledge graph data structure (block 304). In some embodiments, the metadata for a user interest may include entities in the knowledge graph data structure that are connected to the user interest by a predefined number of edges, for example by at most one edge, by at most two edges, by at most three edges, by at most four edges, or by at most five edges. Then, for each predefined user interest (e.g., each interest i in I(u)), relationship data indicating one or more relationships between the metadata associated with the user interest and the metadata associated with the user may be determined (block 306). Table 2 provides example categories of user interests, example metadata associated with each category of user interest that may be extracted from the predefined knowledge graph data structure, and example user metadata that may be related to the metadata.

TABLE 2
User interest categories, user interest metadata, and user metadata

| User | Example Metadata | |
|---|---|---|
| Interest | (acquired from knowledge | Related User |
| Category | graph data structure) | Metadata |
| Company | Company executives, | User's role in |
| | technology sectors in | their organization, |
| | which the company | products that the |
| | participates, products | user has purchased or |
| | offered by the company, | used, geographic |
| | services offered | regions where the |
| | by the company, | user lives or works, etc. |
| | geographic regions in | |
| | which the company | |
| | is active, major | |
| | partners or collaborators | |
| | of the company, | |
| | etc. | |
| Person | Person's name, people | User's role in |
| | or organizations | their organization, |
| | affiliated with the person, | user's technical, |
| | the person's role | professional, or |
| | in an organization, | academic background, |
| | the person's technical, | etc. |
| | professional, or academic | |
| | background, etc. | |
| Industry | Companies involved | User's technical, |
| | in the industry, | professional, or |
| | products associated | academic background, |
| | with the industry, | products that |
| | services associated | the user has purchased |
| | with the industry, | or used, etc. |
| | people associated with | |
| | the industry, etc. | |

The output of process 300 may be a data structure that links metadata associated with each predefined user interest to metadata associated with the user (referred to as the “user interest-user data structure” in block 308). From the user interest-user data structure, the context data structure associated with the selected user interest (e.g., a data structure C(i) for each predefined interest i in the set of predefined user interests I(u)); step 104 of method 100) may be constructed.

In method 100, the constructed context data structure and the user activity data associated with the selected user interest may be provided to a trained machine learning model to generate one or more new user interests (i.e., user interests in addition to the predefined user interests) (step 106 of method 100). The machine learning model may be or may include an unsupervised learning model, a supervised learning model, a neural network, a language model, or any other suitable machine learning model. In some examples, the machine learning model is a large language model (LLM). The large language model may be a third-party large language model such as OpenAI's GPT-3, GPT-3.5, or GPT-4, a model from Google's LaMDA, PaLM, or Gemini families, or a model from MetaAl's LLAMA family. Alternatively, the large language model may be a proprietary large language model developed, e.g., by the user or by an organization to which the user belongs (e.g., the user's company).

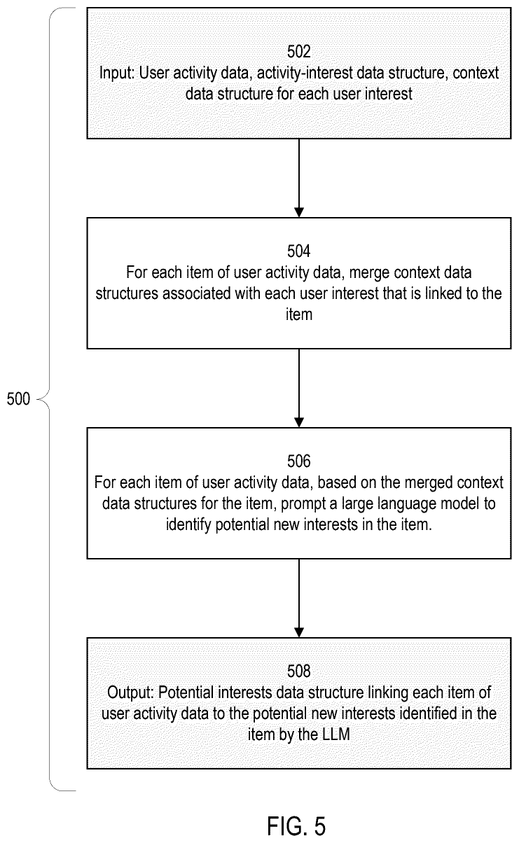

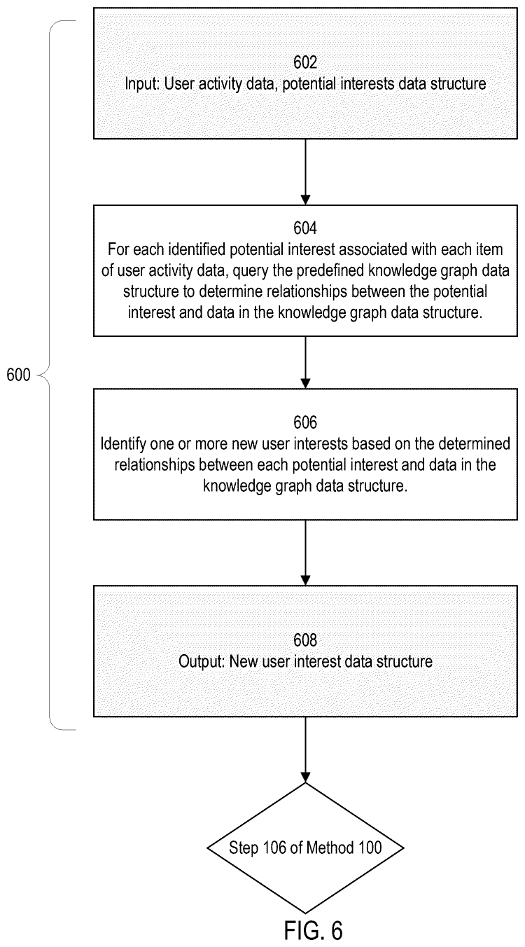

If the machine learning model is an LLM, step 106 may comprise several sub-processes, including a prompting subprocess in which a prompt for the LLM is generated and an identification process in which new user interests are identified from the LLM output. A process 500 for prompting an LLM to identify potential new interests in user activity data is provided in FIG. 5, and a process 600 for determining new user interests from the potential new interests identified by the LLM is provided in FIG. 6. Processes 500-600 may be executed during step 108 of method 100. Processes 500-600 may be performed, for example, using one or more electronic devices implementing a software platform. In some examples, processes 500-600 are performed using a client-server system, and the blocks of processes 500-600 are divided up in any manner between the server and a client device. In other examples, the blocks of processes 500-600 are divided up between the server and multiple client devices. In other examples, processes 500-600 are performed using only a client device or only multiple client devices. In processes 500-600, some blocks are, optionally, combined, the order of some blocks is, optionally, changed, and some blocks are, optionally, omitted. In some examples, additional steps may be performed in combination with the processes 500-600. In some examples, steps of processes 500-600 may be performed in a different order than the order that is depicted in FIGS. 5-6. Accordingly, the operations as illustrated (and described in greater detail below) are exemplary by nature and, as such, should not be viewed as limiting.

The inputs to process 500 (block 502, FIG. 5) may include the acquired user activity data (e.g., the set D(u) of user activity data), the activity-interest data structure output by process 200 (e.g., the subsets D′(u, i) of user activity data associated with each user interest i in the set of predefined user interests I(u)—see FIG. 2), and the context data structure for each predefined user interest (e.g., the data structure C(i) for each predefined interest i in the set of predefined user interests I(u)). Each item of user activity data may be associated with one or more predefined user interests; these associations may be indicated in the activity-interest data structure. Each predefined user interest may, in turn, have an associated context data structure. If a given item of user activity data is associated with multiple predefined user interests, then that item of user activity data may be linked to multiple context data structures. At block 504 of process 500, for each item of user activity data, the context data structures associated with each user interest that has been identified in the item of user activity data may be merged. Merging may involve combining the context data structures to form a single, merged context data structure. Any overlap between two context data structures, e.g., the same entity or relationships, may be treated as a single common item in the merged data structure. At this stage, any potential conflicting data may be retained and presented to the LLM. The knowledge graph may be periodically reviewed for such conflicts and the conflicts may be resolved (e.g., using external data).

Once the context data structures associated with an item of user activity data have been merged, an LLM may be prompted to identify potential new user interests in the item of user activity data based on the merged context data structures (block 506). The prompt may be configured to cause the LLM to interpret the item of user activity data in a context defined by the merged context data structures and identify topics, concepts, objects, people, locations, or other entities mentioned or indicated in the item that may be of interest to the user.

In some embodiments, the LLM is prompted with a text input comprising instructions to analyze a given item of user activity data as well as an expected form and format of the LLM output. The prompt can also contain instructions specific to the type of user activity data that is being analyzed. For example, if the item of user activity data is an email, then the prompt may instruct the LLM to pay close attention to specific fields in the email such as, for example, the sender or recipient lists. The prompt can also contain the context within which the item is to be analyzed.

A prompt for an email may comprise instructions for the LLM, user activity context, and an item of user activity data to analyze. Example instructions for the LLM may be as follows: “You are a news recommendation AI assistant for finance professionals. You analyze their communication and activity and identify potential new interests to track. User interests may be companies, people, regions, business sectors and topics. You will be given an item of user communication or user activity to analyze (delimited by triple backticks), and some useful contextual information. Use the context to analyze the item and identify potential user interests as accurately as possible. For each identified interest, give an importance rating of ‘High’, ‘Medium’ or ‘Low’. For each identified interest, give its type (Company, Person, Region, Industry Sector, Topic), a reason why it appears to be a user interest and an associated importance rating. If the type is person, try to identify the person's affiliation and role. For email communication, use the signature to find clues to the sender. Finally, output a one sentence summary of the communication item.”

The user activity context may comprise metadata about the user, known interests of the user and their attributes, and a history of prior conversations. Example user context data that may be provided to the LLM is provided in Table 3.

TABLE 3
Example user context provided to LLM-Email Prompt

| | Known User Interests and | |
|---|---|---|
| User Metadata | Attributes | Conversation History |
| Name: Matthew | Interest: Fluxion | Tue, Aug. 8, 2023 5:09 |
| Carter | Description: AI | PM: The email is |
| Position: | platform to | from Sophia Thompson, |
| CEO of | create personalized | Head of Market Data |
| Fluxion | investment | at Valor Fidelis- |
| | strategies. | London Branch, to |
| | People: Matthew Carter | Nathaniel Pierce at |
| | (CEO), Henry | MeridianX, asking |
| | Ashford (CRO) | about a service |
| | Partners: MeridianX, | called Cityvine |
| | Nexus | and whether |
| | Regions: USA | MeridianX provides |
| | Sectors: Software | anything similar, |
| | Products: Intelligent | in the context of |
| | Assistant | CRM and AI. |

An item of user activity data that may be provided to the LLM to analyze may be an email, e.g., an email between the user and a coworker. An example email is provided in Table 4.

TABLE 4
Example user activity data provided to LLM-Email Prompt

| Item | |
|---|---|
| Type | Email |
| Subject | [External] FW: Query (VF CIB) |
| From | Nathaniel Pierce <Nathaniel.pierce@MeridianX.com> |
| To | Matthew Carter <matt.carter@fluxion.com> |
| | Henry Ashford <henry.ashford@fluxion.com> |
| Date | Wed, Aug. 9, 2023 |
| Body | Henry, |
| | Great to connect on LinkedIn. |
| | MeridianX has been seeing success with |
| | MarketMuse/Fluxion for VF CIB's London |
| | office. They've expressed interest in discussing |
| | the solution further in early September. |
| | To prepare for the call, I'd appreciate |
| | any insights you might have on: |
| | Your availability in London during early September. |
| | Cityvine (Banking-Citivine?), an outbound solution |
| | for Outlook that VF CIB mentioned. |
| | Any previous interactions you've had with Cityvine. |
| | They've indicated attendees will include the |
| | Head of GCB IT Reg and Compliance |
| | reporting to the GCB CIO, and the SCIB European CIO. |
| | Thanks in advance for your input! |
| | Best regards, |
| | Nathan Pierce |
| | Account Manager, Strategic Accounts |
| | MeridianX |

Example outputs from the LLM, given the example email prompt, the example user activity data and the example context (Tables 3-4) are shown in Table 5.

TABLE 5
Example LLM Outputs-Email Prompt

| Interest | Type | Reason | Importance |
|---|---|---|---|
| VF CIB | Company | The user is | High |
| | | discussing potential | |
| | | business with VF CIB. | |
| MarketMuse | Company | The user mentions | High |
| | | getting traction on | |
| | | MarketMuse/Fluxion | |
| | | for SCIB in | |
| | | London | |
| Cityvine | Company | The user is asking | High |
| | | about Cityvine, | |
| | | comparing it to Fluxion | |
| Nathaniel | Person- | The user is directly | High |
| Pierce | Affiliation: | communicating | |
| | Meridian X, | with Nathaniel Pierce | |
| | Role: Account | | |
| | Manager, | | |
| | Strategic | | |
| | Accounts | | |
| London | Region | The user is asked | High |
| | | if he will be in | |
| | | London in early September | |
| AI Technology | Topic | The user's company, | High |
| | | Fluxion, is an AI | |
| | | startup and the email | |
| | | discusses AI-related topics | |
| Banking | Industry | The email mentions | Low |
| Compliance | Sector | the Head of GCB | |
| | | IT Reg and Compliance, | |
| | | indicating a potential | |
| | | interest in banking | |
| | | compliance | |

| | |
|---|---|
| Summary | The email is from Nathaniel Pierce of the |
| | Meridian X to Matthew Carter and Henry Ashford |
| | of Fluxion, discussing potential business |
| | with VF CIB, asking about their availability for |
| | a meeting in London, and inquiring about their |
| | experience with a company called Cityvine. |

A second example of context data that may be provided to the LLM with the email prompt is given in Table 6:

TABLE 6
Example user context provided to LLM-Email Prompt

| User | Known User Interests and | |
|---|---|---|
| Metadata | Attributes | Conversation History |
| Name: | Interest: Fluxion | Tue, Aug. 8, 2023 5:09 |
| Matthew | Description: enterprise | PM: The email is |
| Carter | AI startup | from Amanda Dillon, |
| Position: CEO | delivering proactive content | Head of Market |
| of Fluxion | recommendations to financial | Data at Banco Valor |
| | professionals | Fidelis.-London Branch, |
| | People: Matthew Carter | to Nathaniel Pierce at |
| | (CEO), Henry Ashford (CRO) | MeridianX, asking |
| | Partners: MeridianX, Nexus | about a service called |
| | Regions: USA | Cityvine and whether |
| | Sectors: Software | MeridianX provides |
| | Products: Intelligent | anything similar, |
| | Assistant | in the context |
| | | of CRM and AI. |
| | Interest: MeridianX | Wed, Aug. 9, 2023 0:00: |
| | Description: capital | The email is from |
| | markets business, | Nathaniel Pierce |
| | operating a wide | of the Meridian X |
| | range of derivatives, | (MeridianX) to |
| | bond, and equity | Matthew Carter and |
| | markets, owns the | Henry Ashford of |
| | London Stock Exchange | Fluxion, discussing |
| | People: Daniel | potential business |
| | Miller (CEO)-CRM, | with VF CIB, asking |
| | Charles Montgomery | about their availability |
| | (Chairperson)-KG, | for a meeting in |
| | Nathaniel Pierce (Account | London, and |
| | Manager, VF)-Inbox | inquiring about their |
| | Partners: MeridianX, Nexus | experience with a |
| | Regions: London, UK | company called |
| | Sectors: Capital Markets | Cityvine. |
| | Products: Financial markets | Thu, Aug. 10, 2023 |
| | infrastructure, Stock | 12:59 AM: Matthew |
| | exchange, Data | Carter, CEO of |
| | analytics, clearing | Fluxion, responds to |
| | | Nathaniel Pierce of |
| | | MeridianX about a |
| | | potential business |
| | | opportunity with VF |
| | | CIB, mentioning |
| | | that Cityvine is a |
| | | potential partner/data |
| | | source for Fluxion |
| | | and asking for more |
| | | information about |
| | | VF's use of Cityvine. |
| | | Thu, Aug. 10, 2023 |
| | | at 4:29 AM: |
| | | Nathaniel Pierce |
| | | of MeridianX emails |
| | | Matthew Carter and |
| | | Henry Ashford of |
| | | Fluxion, discussing |
| | | VF's interest in |
| | | Cityvine and MarketMuse, |
| | | and proposing |
| | | a call with VF's IT |
| | | partners on August |
| | | 24th or 25th. |

Table 7 provides a second example item of user activity data that may be provided to the LLM along with the email prompt and the context data in Table 6:

TABLE 7
Example user activity data provided to LLM-Email Prompt

| Item | |
|---|---|
| Type | Email |
| Subject | Re: [External] FW: Query (VF CIB) |
| From | Henry Ashford <henry.ashford@Fluxion.com> |
| To | Pierce, Nathaniel <nathaniel.pierce@MeridianX.com>; |
| | Matthew Carter <matt.carter@Fluxion.com>; |
| | Evans, Liam <liam.evans@MeridianX.com> |
| Date | Thu, Aug. 10, 2023 1:13 PM |
| Body | Hi Nathan, |
| | Pleasure connecting via email! Per Matt, both |
| | pre-noon ET slots on 8/23 and 8/24 work |
| | for VF. While I travel on 8/24, |
| | I'm available for a call on 8/25. |
| | Full disclosure: I know Cityvine's CEO well |
| | (non-competitive firms). They focus on |
| | email intel (clicks, engagement) for equity |
| | research sales, while Fluxion uses AI for |
| | persona-based investment strategies. |
| | As Matt mentioned, I've had initial talks with |
| | Cityvine's CEO (Quinn) about |
| | exploring their email data for Fluxion. |
| | Happy to discuss further if you'd like more details. |
| | Best, |
| | Henry |

Based on the context data in Table 6 and the user activity data in Table 7, the prompted LLM may output the following data (Table 8):

TABLE 8
Example LLM Outputs-Email Prompt

| Interest | Type | Reason | Importance |
|---|---|---|---|
| VF CIB | Company | The user is discussing potential | High |
| | | business with VF CIB. | |
| Cityvine | Company | The user mentions having a good | High |
| | | relationship with the | |
| | | CEO of Cityvine and | |
| | | discusses the possibility | |
| | | of leveraging their | |
| | | email intelligence as | |
| | | a data source for | |
| | | Fluxion. | |
| Quinn | Person | The user mentions | High |
| (CEO of | | having preliminary | |
| Cityvine) | | discussions with | |
| | | Quinn, indicating a | |
| | | professional relationship. | |
| MeridianX | Company | The user is in | High |
| | | communication with | |
| | | Nathaniel Pierce from | |
| | | MeridianX regarding | |
| | | a potential business | |
| | | opportunity. | |
| Nathaniel | Person- | The user is in direct | High |
| Pierce | Affiliation: | communication with | |
| | MeridianX; | Nathaniel Pierce | |
| | Role: Account | regarding a potential | |
| | Manager, VF | business opportunity. | |
| Email | Topic | The user discusses the | High |
| Intelligence | | potential of leveraging email | |
| | | intelligence from Cityvine | |
| | | for Fluxion. | |
| AI-based | Topic | The user mentions that | High |
| Investment | | Fluxion is focused | |
| Strategy | | on persona-based insights | |
| | | delivery via AI. | |

| | |
|---|---|
| Summary | Henry Ashford of Fluxion responds to Nathaniel |
| | Pierce of MeridianX, confirming availability for a |
| | call with VF, discussing the potential of |
| | leveraging Cityvine's email intelligence for Fluxion, |
| | and expressing his familiarity with Cityvine and its CEO. |

A prompt for a document may be similar to a prompt for an email but may contain different fields for the item and a few minor changes in the context. An example item is provided in Table 9.

TABLE 9
Example user activity data provided to LLM-Document Prompt

| Item | |
|---|---|
| Type | Document |
| Author | Fluxion |
| Region | Canada |
| Series | Fluxion Roadshow: Montreal |
| Title | AI Revolutionizes Investment Strategies: Building |
| | Personalized Portfolios for Every Client |
| People | John Smith (Managing Director, Financial |
| | Services Practice Lead, Audax), Matthew |
| | Carter (Founder & Chief Executive Officer, |
| | Fluxion), Nicola Bronzini (Director Of |
| | Investment Banking, MeridianX Data & |
| | Analytics), Faisal Malik (Global Technology |
| | Strategist, Nexus), Owen Wilmslow (Managing |
| | Director, Banking & Capital Markets, Nexus), |
| | Henry Ashford (Chief Revenue Officer, Fluxion) |
| Body | Investment personalization through AI is |
| | revolutionizing the financial landscape. Fluxion, |
| | Nexus, and MeridianX are coming together |
| | to showcase how cutting-edge AI can be |
| | harnessed to develop bespoke investment |
| | strategies for your clients. |
| | Discover how AI can empower you to: |
| | Craft Personalized Portfolios: Leverage AI |
| | to analyze vast sets of financial data, |
| | client goals, and risk tolerances to build |
| | tailored investment plans for each client. |
| | Unlock Hidden Insights: Go beyond |
| | traditional analysis. AI can uncover hidden |
| | connections within data, uncovering new |
| | investment opportunities that fit each |
| | client's unique profile. |
| | Automate Rebalancing and Optimization: |
| | AI can constantly monitor and adjust |
| | portfolios based on market fluctuations |
| | and client goals, ensuring optimal |
| | performance over time. |
| | Enhance Client Communication: AI can |
| | generate insightful reports and |
| | recommendations, allowing you to deliver |
| | clear and personalized communication |
| | to build stronger client relationships. |
| | Join us for real-world examples of how AI is |
| | transforming investment banking. Learn |
| | how to leverage this powerful technology to |
| | create personalized investment strategies and |
| | gain a competitive edge in the market. |
| | Streamline information gathering: Unleash the |
| | power of unprompted AI to surface relevant |
| | information and adapt to each banker's |
| | preferences based on their behavior and feedback. |
| | Maximize CRM investment ROI: Harness |
| | AI to drive banker engagement with CRM |
| | data, boosting its effectiveness and ROI. |
| | Amplify market data ROI: Leverage AI to |
| | elevate banker awareness and consumption of |
| | data by proactively highlighting relevant |
| | information from data feeds. |

Example outputs from the LLM, given a document prompt analogous to the example email prompt, the example user activity data and the example context are shown in Table 10.

TABLE 10
Example LLM Outputs-Document Prompt

| Interest | Type | Reason | Importance |
|---|---|---|---|
| Fluxion | Company | The user is attending | High |
| | | a Fluxion event | |
| | | and the company is | |
| | | mentioned multiple | |
| | | times in the document | |
| Matthew | Person-Founder | Matthew Carter is | High |
| Carter | and | a speaker at the | |
| | CEO of Fluxion | event the user is attending | |
| Henry | Person-Chief | Henry Ashford is a | High |
| Ashford | Revenue Officer, | speaker at the event | |
| | Fluxion | the user is attending | |
| Nexus | Company | Nexus is mentioned | High |
| | | as a partner of | |
| | | Fluxion in the document | |
| MeridianX | Company | MeridianX is mentioned | High |
| | | as a partner of | |
| | | Fluxion in the document | |
| Nicola | Person-Director of | Nicola Bronzini is | High |
| Bronzini | Investment Banking, | a speaker at the | |
| | MeridianX Data and | event the user is attending | |
| | Analytics | | |
| AI-driven | Topic | The document discusses | High |
| Investment | | the use of AI- | |
| Strategy | | driven insights in | |
| | | banking, which could | |
| | | be of interest to the user. | |
| Audax | Company | John Smith from | Low |
| | | Audax is a speaker at | |
| | | the event the user | |
| | | is attending | |
| John Smith | Person-Managing | John Smith is a | Low |
| | Director, Financial | speaker at the event the | |
| | Services Practice | user is attending | |
| | Lead, Audax | | |

| | |
|---|---|
| Summary | The document is about an event organized by Fluxion, |
| | discussing the application of AI in investment banking, |
| | featuring speakers from Fluxion, Nexus, |
| | MeridianX, and Audax. |

As shown in the examples above, the output of process 500 may be a data structure that connects each item of user activity data to one or more potential new user interests identified in the item by the LLM (the “potential interests data structure”-see block 508). This data structure, along with the user activity data, may be provided as inputs to process 600 (block 602, FIG. 6).

In process 600, the predefined knowledge graph data structure may be queried for each identified potential interest associated with each item of user activity data to determine relationships between the potential interest and data (e.g., predefined user interests and metadata items associated with the predefined user interests) in the knowledge graph data structure (block 604). Querying the predefined knowledge graph data structure may involve identifying paths and node combinations in the predefined knowledge graph data structure that connect two entities. The query can be formulated in a suitable query language (e.g., SPARQL) or may be a programmatic manipulation of the graph. Determining a relationship between a potential interest and data in the knowledge graph data structure may comprise constructing a combination of edges and nodes to connect a node representing the potential interest and an existing node in the context data structure.

The determined relationships may be used to identify which of the potential interests likely represent actual interests of the user (block 606). In some examples, new user interests are determined based on the number of new edges and nodes required to connect each potential interest to the knowledge graph data structure. A potential interest that can be connected to an existing node in the knowledge graph data structure by constructing a single edge may be identified as a likely new interest, while a potential interest that requires the construction of multiple edges and nodes in order to be connected to an existing node in the knowledge graph data structure may not be identified as a new user interest. The output of process 600 (block 608) may be a data structure that stores the newly identified user interests (the “new user interest data structure”, e.g., a data structure l′(u, i) containing user interests derived from each predefined user interest i in the set of predefined user interest I(u)).

To quantify the relevance of each newly identified user interest to the user, an importance score may be generated for each new user interest. The importance score for a new user interest may be a numerical value (e.g., a floating value between 0 and 1) that is generated based on LLM relevance categories associated with the newly identified user interest. LLM relevance categories may be textual phrases that indicate the strength or intensity of relevance, e.g., phrases such as “High,” “Medium,” or “Low.” The magnitude of an importance score for a new user interest may correspond to the new user interest's relevance compared to the other newly identified user interests.

In some embodiments, the LLM can be configured to determine that it needs additional information or context to answer a user query and uses a function call to fetch that additional context. Thus, if the LLM finds ambiguous entities upon examining a content item, the LLM may query the context engine (or the collected subgraph) to obtain related context and thus resolve the ambiguity. The related context may be the same as context data that would have been embedded in the prompt to LLM or it may be specific additional information that the LLM requests. Accordingly, the LLM can function not as a reactive entity extractor, but rather a more proactive interpreter of user work data.

In other words, rather than receiving a prompt and contextual information and generating a response regardless of the presence of any potential ambiguities, the LLM may be configured to identify ambiguities in the prompt and/or the contextual information. If an ambiguity is identified, the LLM may resolve the ambiguity, for example by querying the knowledge graph to obtain additional contextual information.

In these embodiments, the LLM can be any LLM with the capacity to identify and resolve ambiguities. For example, the LLM can be or comprise a Mem-GPT system or a component thereof. In this system, the LLM may be a fixed-context LLM that has been augmented with a hierarchical memory system and functions that let it manage its own memory. The LLM may take a “main context” (analogous to OS main memory/RAM) as input and may output text interpreted by a parser. Main context may be the standard fixed-context window in modern language models-anything in main context may be considered in-context and can be accessed by the LLM processor during inference. In response to the main context input, the LLM may output text, which may be interpreted by a parser. The LLM output may contain a function call. If so, the system may use the function call to invoke an external API to fetch additional data. This additional data is supplied to the LLM along with information in its previous prompt. Since LLMs may generate function calls in multiple consecutive iterations. A response to the original question may also be formulated as a function call. When this function is called or when there is no further function call in the LLM output, then that is considered the final LLM response. MemGPT may use functions to move data between main context and external context (analogous to OS disk memory). External context may refer to any information that is held outside of the LLMs fixed context window. This out-of-context data must always be explicitly moved into main context in order for it to be passed to the LLM processor during inference. When the processor generates a function call (which may be done without any user intervention), it can request control ahead of time to chain together functions. When yielding, the processor may be paused until the next external event (e.g., a user message or scheduled interrupt). Additional details about Mem-GPT systems can be found in MemGPT: Towards LLMs as Operating Systems (Packer et al., 2023, https://arxiv.org/abs/2310.08560).

In a Mem-GPT system, the main context that is input into the LLM can be divided into three components: system instructions, which may hold the base LLM instructions (e.g., information describing MemGPT functions and control flow to the LLM), conversational context, which may hold a first-in-first-out (FIFO) queue of recent event history, and working context, which serves as a working memory scratchpad for the agent. The user activity data and the context data structure may be components of the main context. The external context may include information that is not immediately visible to the LLM processor but can be brought into main context through appropriate function calls. The predefined knowledge graph data structure may be a component of the external context.

In some examples, at step 106 of method 100, the LLM (e.g., as a component of a Mem-GPT system) may determine that it requires information or context in addition to that which is provided by the context data structure in order to identify potential new user interests. For example, the LLM may identify an entity in the input user activity data that, based on the context data structure alone, is ambiguous. To resolve the ambiguity, the LLM may query the knowledge graph data structure. The query can be a generic request for additional information about the ambiguous entity, in which case a process such as process 300 (FIG. 3) may be executed to construct a context data structure associated with the ambiguous entity. In other examples, the query can include specific questions or requests for specific information. Once the requested information is provided, the LLM may proceed with its identification of the potential new user interests.

In some embodiments, the LLM is configured to determine which context or information is required in order to interpret an item of user activity data or a set of user activity data. In such cases, the user activity data may be provided to the LLM without a context data structure. The LLM may identify potential user interests based on the user activity data. For each potential user interest, the LLM may determine whether sufficient information is available to accurately interpret the user interest. If insufficient information or context is available, the LLM may query the knowledge graph data structure to request additional context or information.

Referring again to FIG. 1, after the one or more new user interests have been generated at step 106, a user-specific content recommendation may be generated based on the one or more new user interests (step 108). Example content items that may be recommended include (but are not limited to) files (e.g., text files, image files, video files, audio files, etc.), news reports, links to webpages, movies, books, products, services, contact information for a person or an organization, and briefings for upcoming meetings. The generated content recommendation may be provided to the user, for example by displaying a graphical user interface comprising the content recommendation on the user's computer system (step 110).

In some examples, the user-specific content recommendation is generated in response to a trigger event. The trigger event can be an upcoming user activity, such as a meeting, a presentation, or a conference, or a change in user activity, such as the creation of a new file. The trigger event may also be time-based. For instance, a user-specific content recommendation may be generated periodically (e.g., once per day). Additionally or alternatively, content recommendations may be generated in response to conditions defined by a set of rules. If, for example, the user is an employee of a company, user-specific content recommendations may be generated based on rules associated with the prices of certain securities or the values of various assets.

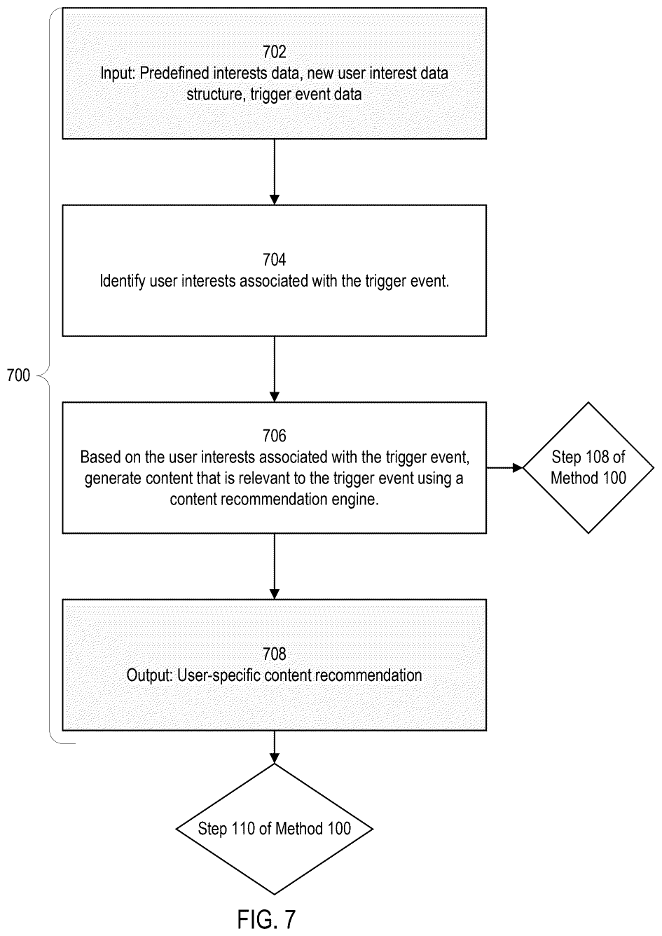

FIG. 7 provides a process 700 for generating user-specific content recommendations that may be executed during steps 108-110 of method 100. Process 700 is performed, for example, using one or more electronic devices implementing a software platform. In some examples, process 700 is performed using a client-server system, and the blocks of process 700 are divided up in any manner between the server and a client device. In other examples, the blocks of process 700 are divided up between the server and multiple client devices. In other examples, process 700 is performed using only a client device or only multiple client devices. In process 700, some blocks are, optionally, combined, the order of some blocks is, optionally, changed, and some blocks are, optionally, omitted. In some examples, additional steps may be performed in combination with the process 700. In some examples, steps of process 700 may be performed in a different order than the order that is depicted in FIG. 7. Accordingly, the operations as illustrated (and described in greater detail below) are exemplary by nature and, as such, should not be viewed as limiting.

As shown in FIG. 7, the inputs to process 700 may include the predefined interest data, the new interest data structure, and data indicating a trigger event (block 702). A trigger event related to a user interest may be a meeting or an event (e.g., a deal announcement with a company that is a user interest). The trigger event data may be analyzed to identify user interests (e.g., of the plurality of predefined user interests or of the one or more newly identified user interests) associated with the trigger event (block 704). A content recommendation engine may then be used to generate content that is relevant to the trigger event based on the user interests associated with the trigger event (block 706). The content recommendation engine may use identified user interests and user feedback to recommend relevant content (e.g., news, research reports, content internal to an organization of which the user is a member, etc.) to the user. The content generated by the recommendation engine may then be output to the user (block 708).

Importance scores for the newly identified user interests may accounted for when generating a user-specific content recommendation. If multiple new user interests are associated with a trigger event, then the new user interest with the highest importance score or the importance score with the greatest magnitude may be used to generate a content recommendation in response to the trigger event. This may increase the likelihood that the recommended content is useful to the user.

In some examples, after a content recommendation is provided to the user, user feedback about the content recommendation may be received. The feedback may indicate, for example, whether the user found the recommended content to be useful or relevant. The feedback can be used to update (e.g., numerically) parameters associated with the recommendation engine (see block 706 of process 700) or to improve the prompts that are input into an LLM to identify potential new interests (see process 500 shown in FIG. 5). In some examples, when a user clicks on or saves a recommendation or marks a recommendation as “useful,” the recommendation engine may be configured to strengthen weights associated with factors that led the engine to the recommendation, e.g., specific interests of the user that led to the recommendation. In other examples, a LLM prompt may be changed to include metadata from recommendations along with the associated feedback, so that the LLM may consider the user feedback when identifying new interests. Such updates may be implemented automatically (e.g., by an offline LLM or other machine learning model) or manually (e.g., by the user or by another member of an organization to which the user belongs).

As discussed, a user-specific content recommendation may be provided to the user by displaying a graphical user interface (GUI) comprising the content recommendation on a computer system. In some examples, the interface is a GUI for a communication medium. For example, the interface may be a GUI for an email application (e.g., Microsoft Outlook), an instant messaging application (e.g., WhatsApp), or a business communication platform (e.g., Microsoft Teams, Slack, etc.). The GUI may provide user controls that allow the user to input feedback about the content recommendation.

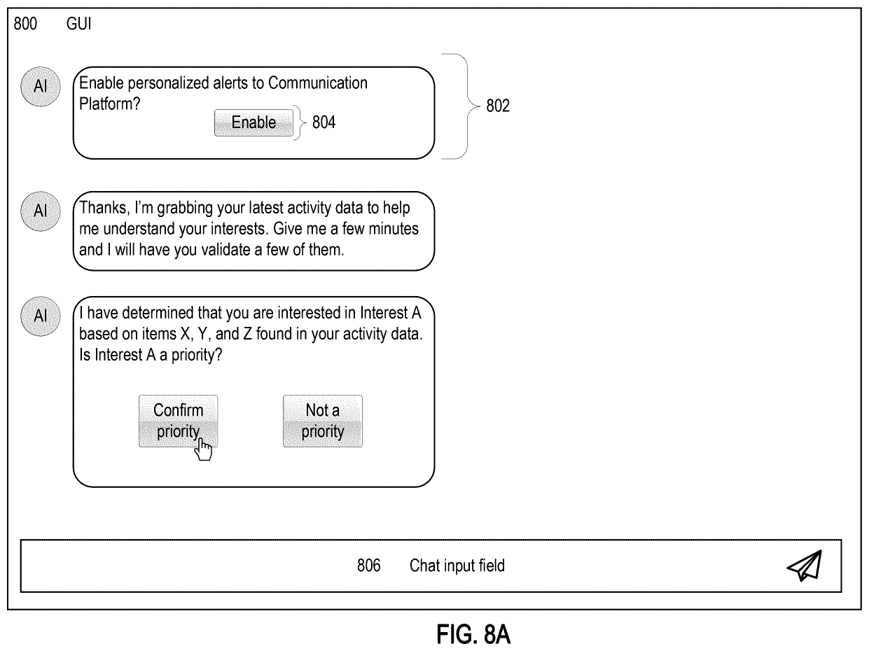

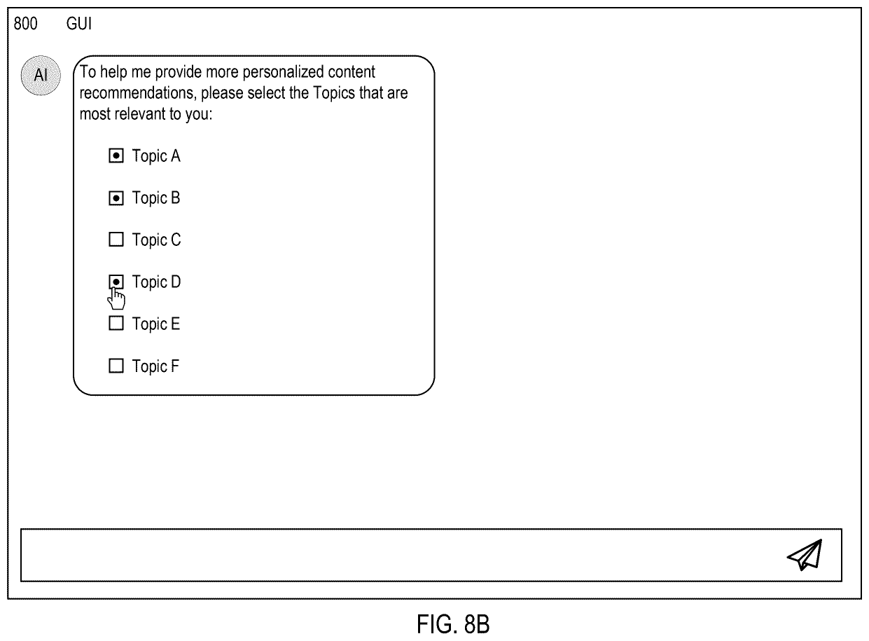

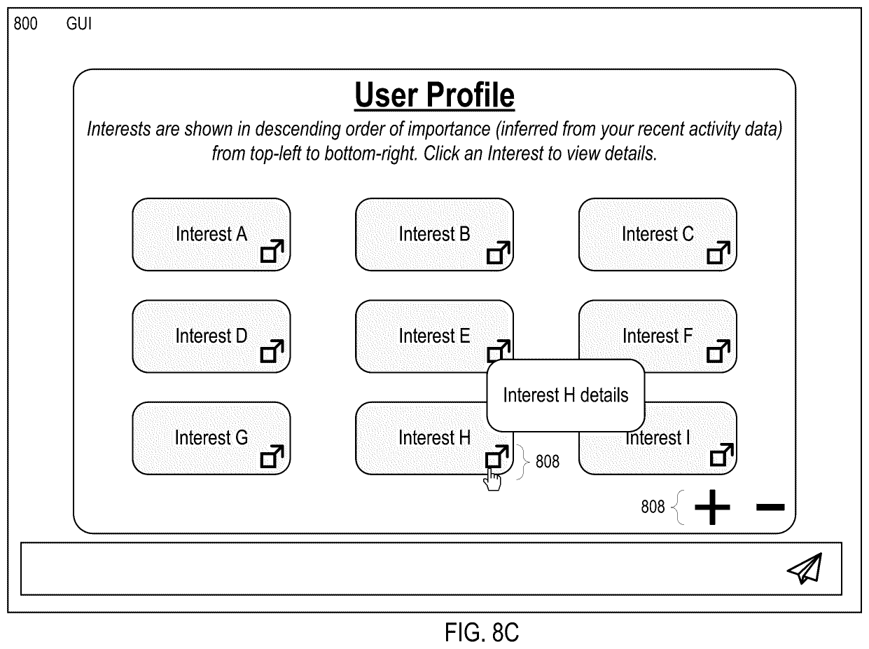

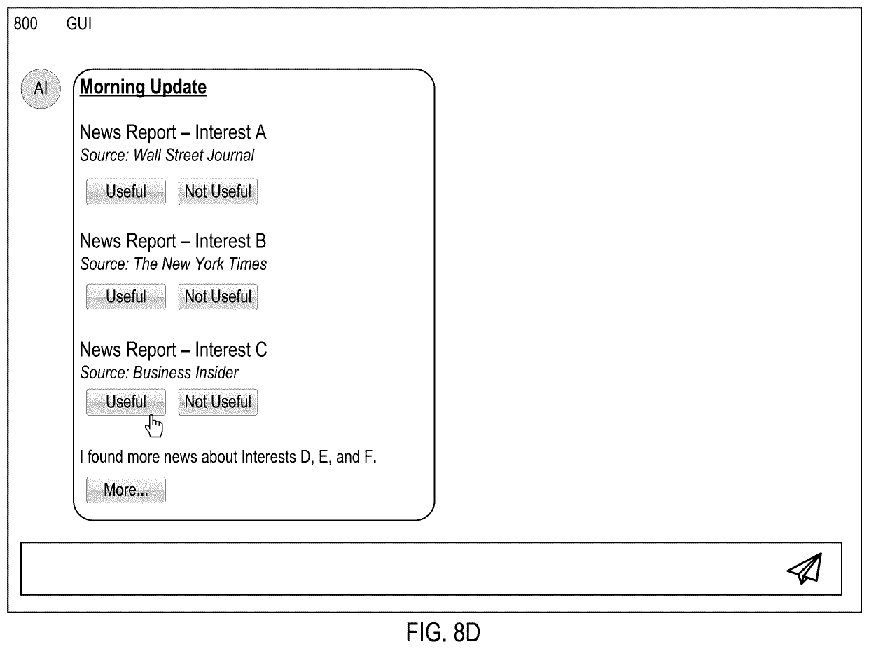

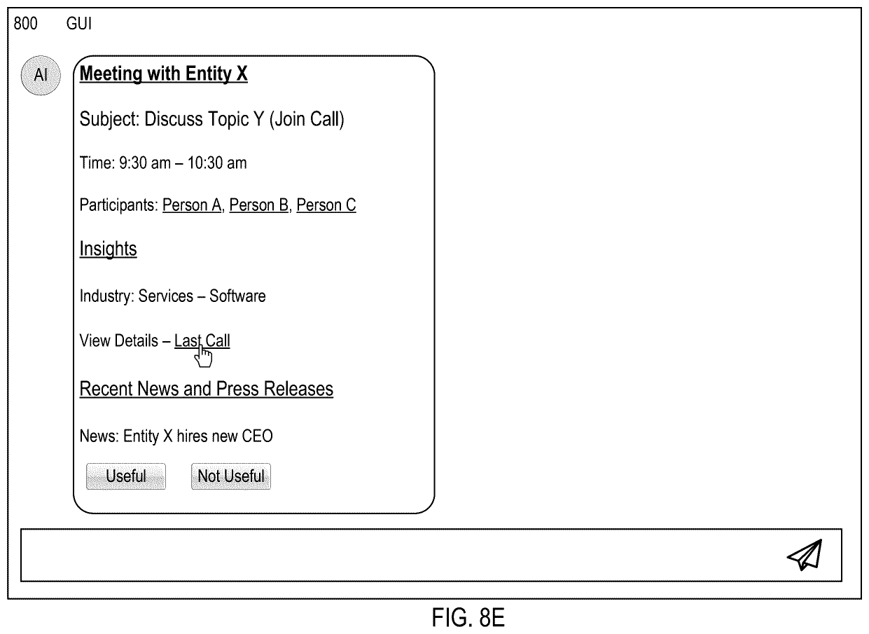

An example GUI 800 for providing user-specific content recommendations is shown in FIGS. 8A-8E. GUI 800 may be a GUI for a communication platform such as Microsoft Teams. The user-specific content recommendations may be provided in a conversation window by an artificial intelligence (AI) chatbot. Recommendations or other requests may be sent to the user by the chatbot as chats or messages 802. When a recommendation is provided or a request for information is made, user input controls 804 may be provided within the chat that allow the user to quickly respond to the chatbot or provide feedback about a content recommendation. In some examples, the user may interact with the chatbot (e.g., to provide written feedback about a content recommendation) using a chat input field 806.

During the user's first use of the chatbot, the user may be prompted by the chatbot to enable personalized alerts and content recommendations. Enabling the content recommendations may trigger the acquisition of user activity data. User interests may be identified based on the acquired user activity data using, e.g., method 100 (see FIG. 1). The user may be asked by the chatbot to confirm one or more of the identified interests (FIG. 8A-8B). In some examples, a user profile for the user may be generated and displayed using GUI 100, as shown in FIG. 8C. The user profile may list the interests that have been identified for the user and may include user controls 808 that allow the user to view a description of each identified interest, input interests, or remove interests.

User content recommendations may take numerous forms. For example, as shown in FIG. 8D, a content recommendation may be a “Morning Update” comprising a list of news reports that may be relevant to the user based on the identified user interests. The user may be enabled to flag each suggested news report as either “useful” or “not useful”. A user content recommendation can also be a meeting briefing that is provided to the user in advance of a scheduled meeting, as shown in FIG. 8E. The meeting briefing may include links that allow the user to join the call, information about the time and date of the call, information about the call invitees (e.g., links to the invitees company profiles or LinkedIn pages), details about previous calls with the same entity or same group of people, potentially relevant news reports or press releases, or combinations thereof. Again, the user may be prompted to flag each the recommendation as either “useful” or “not useful”.

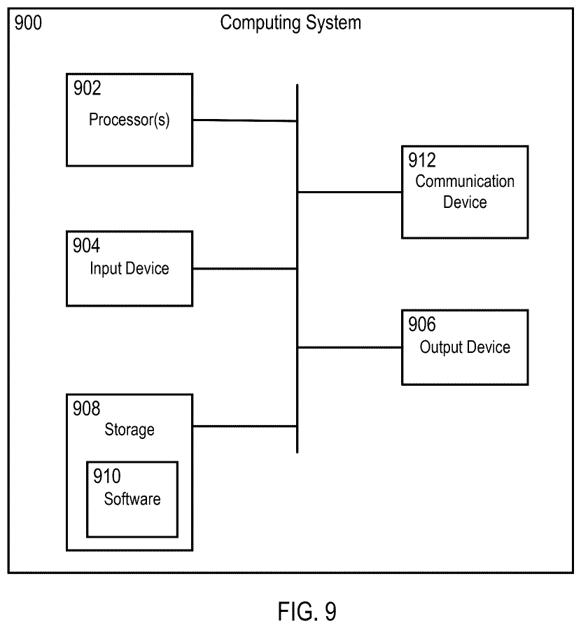

FIG. 9 shows an exemplary computer system 900 that can be used to execute the described methods (e.g., method 100) for organizing a plurality of selectable software applications and tools. Computer system 900 can be any suitable type of microprocessor-based device, such as a personal computer, workstation, server, or handheld computing device (portable electronic device) such as a phone or tablet, or dedicated device. As shown in FIG. 14, computer system 900 may include one or more classical (binary) processors 902, an input device 904, an output device 906, storage 908, and a communication device 912.

Input device 904 and output device 906 can be connectable or integrated with system 102. Input device 904 may be any suitable device that provides input, such as a touch screen, keyboard or keypad, mouse, or voice-recognition device. Likewise, output device 906 can be any suitable device that provides output, such as a display, touch screen, haptics device, or speaker.

Storage 908 can be any suitable device that provides storage, such as an electrical, magnetic, or optical memory, including a RAM, cache, hard drive, removable storage disk, or other non-transitory computer readable medium. Communication device 912 can include any suitable device capable of transmitting and receiving signals over a network, such as a network interface chip or device. The components of computer system 900 can be connected in any suitable manner, such as via a physical bus or via a wireless network.

Processor(s) 902 may be or comprise any suitable classical processor or combination of classical processors, including any of, or any combination of, a central processing unit (CPU), a field programmable gate array (FPGA), and an application-specific integrated circuit (ASIC). Software 910, which can be stored in storage 908 and executed by processor(s) 902, can include, for example, the programming that embodies the functionality of the present disclosure. Software 910 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 908, that can contain or store programming for use by or in connection with an instruction execution system, apparatus, or device.

Software 910 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 900 can implement any operating system suitable for operating on the network. Software 910 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for providing user-specific content recommendations to a user, the method comprising:
obtaining user activity data associated with the user, wherein the user activity data is associated with a predefined user interest of a plurality of predefined user interests associated with the user;
constructing a context data structure associated with the selected user interest based on a predefined knowledge graph data structure associated with the plurality of predefined user interests;
generating one or more new user interests by providing the constructed context data structure and the user activity data to a trained machine learning model;
generating a user-specific content recommendation based on the one or more new user interests; and
providing the user-specific content recommendation to the user.

2. The method of claim 1, wherein constructing the context data structure comprises:
acquiring metadata associated with the selected user interest from the predefined knowledge graph data structure; and
acquiring metadata associated with the user.

3. The method of claim 2, further comprising:
determining relationship data indicating one or more relationships between the metadata associated with the selected user interest and the metadata associated with the user.

4. The method of claim 1, wherein the trained machine learning model is a large language model.

5. The method of claim 4, wherein providing the constructed context data structure and the user activity data to the trained machine-learning model comprises:
generating a prompt for the large language model to identify one or more potential interests related to the selected user interest using the constructed context data structure; and
providing the prompt to the large language model.

6. The method of claim 5, further comprising:
determining one or more relationships between the one or more potential interests identified by the large language model and data in the predefined knowledge graph data structure.

7. The method of claim 6, wherein the one or more new user interests are generated based on the one or more relationships between the one or more entities identified by the large language model and data in the predefined knowledge graph data structure.

8. The method of claim 1, further comprising:
generating, for each new user interest of the one or more new user interests, an importance score indicating a relevance of the respective new user interest to the user.

9. The method of claim 8, wherein generating an importance score for a new user interest comprises mapping a large language model relevance category associated with the new user interest to a numerical value.

10. The method of claim 8, wherein the user-specific content recommendation is generated based on the magnitudes of the importance scores for the one or more new user interests.

11. The method of claim 1, further comprising:
receiving an indication of a recommendation trigger event; and
providing the user-specific content recommendation based on the recommendation trigger event.

12. The method of claim 1, further comprising:
receiving a user request for additional information associated with the user-specific content recommendation; and
providing an updated user-specific content recommendation comprising the additional information in response to the user request.

13. The method of claim 1, further comprising:
receiving user feedback associated with the user-specific content recommendation.

14. The method of claim 13, wherein a recommendation engine is used to generate the user-specific content recommendation, wherein the method further comprises:
updating one or more parameters associated with the recommendation engine based on the user feedback.

15. The method of claim 1, wherein providing the user-specific content recommendation comprises displaying a graphical user interface comprising the content recommendation on a computer system.

16. The method of claim 15, wherein the graphical user interface is a graphical user interface for a communication platform.

17. The method of claim 1, wherein the user-specific content recommendation comprises a news report associated with a new user interest of the one or more new user interests.

18. The method of claim 1, further comprising updating the plurality of predefined user interests based on the one or more new user interests periodically or upon receipt of a threshold volume of user activity data.

19. A system for providing user-specific content recommendations to a user, the system comprising one or more processors configured to:
obtain user activity data associated with the user, wherein the user activity data is associated with a predefined user interest of a plurality of predefined user interests associated with the user;
construct a context data structure associated with the selected user interest based on a predefined knowledge graph data structure associated with the plurality of predefined user interests;
generate one or more new user interests by inputting the constructed context data structure and the user activity data to a trained machine-learning model; and
generate a user-specific content recommendation based on the one or more new user interests; and
provide a user-specific content recommendation to the user.

20. A non-transitory computer readable storage medium storing instructions for providing user-specific content recommendations to a user that, when executed by one or more processors of a computer system, cause the computer system to:
obtain user activity data associated with the user, wherein the user activity data is associated with a predefined user interest of a plurality of predefined user interests associated with the user;
construct a context data structure associated with the selected user interest based on a predefined knowledge graph data structure associated with the plurality of predefined user interests;
generate one or more new user interests by inputting the constructed context data structure and the user activity data to a trained machine-learning model; and
generate a user-specific content recommendation based on the one or more new user interests; and
provide a user-specific content recommendation to the user.
